(19) United States
(12) Patent Application Publication
(10) Pub. No.: US 2006/0000495 A1
(43) Pub. Date: Jan. 5, 2006

(54) Novel methods and compositions for remediating submerged deposits

(76) Inventor: Geoffrey Brown, Dacula, GA (US)

Correspondence Address: SMITH, GAMBRELL & RUSSELL, LLP, 1230 PEACHTREE STREET, N.E., SUITE 3100, PROMENADE II, ATLANTA, GA, 30309-3592, US

(21) Appl. No.: 10/883,154

(22) Filed: Jul. 1, 2004

(51) Int. Cl. B08B 3/14

(52) U.S. Cl. 134/42

(57) ABSTRACT

A method is disclosed for treating a submerged surface to remediate unwanted submerged deposits by applying to the submerged unwanted deposit a gel containing an inorganic or organic thickening agent and at least one remediation component having been blended to form a homogeneous mixture and having flow characteristics that will allow the gel to remain substantially attached to a vertical surface for a sufficient period of time to obtain the intended remediation. Also disclosed are films and gel compositions to accomplish the intended results.

### INTRODUCTION AND BACKGROUND

The present invention relates to methods and compositions for killing, bleaching, removing or inhibiting the deposition of microbial slimes, stains or other unwanted deposits in a submerged water environment by using thickened solutions such as gels, or films to deliver remedial chemistries directly to the site of the undesirable depositions. A panoply of products such as, but not limited to, chlorine, bromine or iodine-releasing compounds, non-halogen oxidizers, chelating agents, quaternary ammonium compounds, biocidally active metals, stain or scale removers, alcohols, water balance detectors, etc., that are conformable to thickening or drying can be applied to submerged surfaces or surfaces that will be submerged.

It is known in the art to use chemicals to treat regulated waters with a variety of products in order to perform purposes such as, but not limited to, sanitation, clarification, slime removal, aiding filtration, biofouling prevention and retarding scale and corrosion formation. It is also known in the art to thicken solutions containing active ingredients for specific applications such as liquid dishwashing detergents as shown in U.S. Pat. No. 6,362,147. In that patent, the use of thickened liquid dishwashing detergent compositions containing organic diamines, is shown, although the patent teaches that such compositions are not preferred; see, col. 20, lines 9-10. Obviously, the milieu being treated is aqueous, but the object of this prior art is to treat an entire body of water used for cleaning dishware.

Certain products such as HTH® Black Algae Remover use concentrated quaternary ammonium compound pastes that are applied directly to areas on which black algae are growing. The concentrated paste kills the submerged algae in much the same manner as a gel containing an appropriate algicide. However, a paste product is intrinsically different from the compositions and methods disclosed herein. Specifically, paste production requires the removal of water in order to concentrate the active ingredients. Concentration procedures can include such commercially relevant methods such as evaporation, freeze drying or spray drying. While each of these methods is effective, some products such as cationic materials are less amenable to concentration than others. Gels are novel in that they obviate the problems inherent with concentration. From a manufacturing standpoint, gels are easier to prepare, are more versatile and can serve as a platform for thickening a variety of similar and dissimilar compounds. For these reasons, pastes cannot be construed as equivalent to gel technologies.

In U.S. Pat. No. 5,922,307, Montgomery explains that thickened compositions containing hydrogen peroxide can be used to whiten teeth. In this case, those skilled in the art can learn how solid surfaces can be treated with thickened compositions containing an effective oxidizer. However, Montgomery fails to teach that such compositions are conformable to the selective remediation of unwanted deposits that are continuously submerged in regulated waters. In the mouth, bleaching solutions are often confined to special cups that fit over the teeth to minimize contact with the other parts of the mouth and saliva.

Sodium hypochlorite is known in the art as an effective sanitizer and algicide. Moreover, it is known in the art to use compositions containing hypochlorite to kill algae growing on surfaces. Specifically, in U.S. Pat. No. 6,291,397, Wilkins discloses algicidal methods and compositions for removing algae from surfaces. The composition described by Wilkins contained chlorine and a metal sulfate and a buffer. The method for algae destruction involved rinsing this solution over areas colonized by algae. While this method, as outlined in U.S. Pat. No. 6,291,397, might be practical for exposed, non-submerged surfaces, it would be impractical to remediate algal films growing on the walls of regulated bodies such as swimming pools. The composition and method described by Wilkins would not feasible for those surfaces that are immersed in aqueous bodies.

Similarly, Rees disclosed, in U.S. Pat. No. 6,162,371, that combinations of thickened hypochlorite-containing additives such as sulfamic acid and polyacrylic acid could be used for removing scale from surfaces and for controlling microorganisms. However, it is important to note that Rees, like Castro (U.S. Pat. No. 6,362,147), teaches using methods and compositions which are designed to impact the entire bulk water instead of treating selected surfaces submerged in the water.

Additional literature has validated the art of using polyacrylates and other thickeners to increase the viscosity of hypohalites and other bleaches (Ambuter in U.S. Pat. No. 5,997,764 and Choy in European Patent Publication 0606707). However, neither disclosure mentions the ability of these thickened gels to significantly alter the archetypal method of treating regulated waters as disclosed in the present invention. In other words, neither Ambuter nor Choy teach how one can fundamentally alter the practice of deposit remediation, such as biofilm deposits.

The art also contains examples of using films that contain antimicrobials or other beneficial agents to perform commercially valuable functions. For example, Listerine® PocketPaks™ distributed by Pfizer Consumer Healthcare is comprised of water soluble polymeric films containing antimicrobial and breath-freshening substances. When placed in the mouth, these films dissolve and release ingredients for the benefit of the entire mouth. Hence, the application is not site specific since it treats the entire oral cavity.

The existing art is replete with examples demonstrating the desirability of adding compounds to regulated water for the purpose of sanitation, disinfection, chelation, stain removal or preventing, controlling or eliminating slime formation, inhibiting or remediating scale or corrosion or any such purpose as would be known or obvious to those skilled in the art. But, the existing art does not teach the use of gels or films to remediate unwanted deposits on submerged surfaces without substantially affecting the chemistry of the entire aqueous milieu. In addition, the art does not communicate or presage that gels or films can be used to develop methods that would permit deposit remediation by using incompatible chemistries (e.g., chlorine and hydrogen peroxide). Rather, the extant art clearly teaches that the use of such incompatible chemistries is counterintuitive.

### SUMMARY OF THE INVENTION

The present invention provides compositions, products and methods for remediating unwanted deposits from submerged surfaces in an aqueous environment, or for treating surfaces that will be submerged in an aqueous environment, by treating the surfaces with gels or films that contain one or more of biocides, sanitizers, algicides, slimicides, oxidizers, chelating agents, stain or scale removers, corrosion inhibitors, or any such product or products that can be used to remediate undesirable conditions in a body of water. The terms “remediate” and “remediating” as used herein are intended to mean killing, discoloring or generally removing unwanted deposits on submerged surfaces.

Biocides, algicides, slimicides, oxidizers, corrosion inhibitors, chelating agents and stain and scale removers are commonly used in regulated bodies of water as remediating compounds. Regulated waters as used herein means those natural and man made bodies of water that are used for industrial, recreational and or decorative purposes. In some instances these bodies can be treated with products such as, but not limited to, sanitizers, biocides, oxidizers, slimicides, scale and corrosion inhibitors, clarifiers, algicides, pH adjusters and buffers which can be referred to as remediating chemistries. In some instances these aqueous bodies may be diverted, confined, sprayed or filtered in keeping with the purpose or purposes for which those bodies of water are being regulated. A typical listing of such regulated waters are bodies such as swimming pools, hot tubs, spas, evaporative cooling towers, pulp and paper process waters, waste water, fountains and the like which generally are referred to as re-circulating, water systems. The existing conventional paradigm for treating these bodies of water is to add concentrated liquid or solid chemicals that become significantly less concentrated as the chemical or chemicals become mixed with the water. For example, one gallon of 30% (300,000 ppm) hydrogen peroxide added to a 10,000 gallon pool will only deliver 30 ppm of active hydrogen peroxide to the water. This constitutes a 10,000 fold dilution. When unwanted deposits, such as algae, accumulate on surfaces, an algicide may be added to the water, but the amount that can be added to water is often limited by label directions and/or health and safety concerns.

Clearly the needs exists for a unique technology that provides the benefits inherent to using high concentrations of remediating products on select surfaces instead of treating the entire body of water; such as highly effective, extremely fast results, while accentuating the benefits of using lower concentrations of these products in the body of water itself, whereby the advantages of low impact on water chemistry, minimization of health, safety and equipment concerns can be obtained.

The present invention is intended to fulfill this need by using high levels of remediating chemistries to provide rapid results, by limiting the remediating products to only those sites that require treatment instead of treating the entire body of water. Therefore, upon dilution, the impact of the remediating chemistry on the overall body of water will be negligible. For instance, chlorine resistant algae are commonly observed in swimming pools. In many cases, these algae which deposit on many surfaces in the pool are able to withstand chlorine levels of 20 ppm or higher. The film of microorganisms such as algae, bacteria or fungi deposited on the walls and other surfaces of the pool is termed a “biofilm”. A pool operator wanting to kill these algae would likely brush to remove the biofilm from the surfaces on which it is deposited before adding an effective algicide such as chlorine. The result is to disperse the remnants of the biofilm throughout the entire body of water. In this case a 10,000 gallon pool would require two gallons of 10% sodium hypochlorite in order to achieve a 20 ppm chlorine residual. If the algae were not killed by this treatment, the operator would likely repeat the aforementioned steps, perhaps using a higher level of chlorine. In any case, swimmers would not be able to use the pool until the chlorine residuals had fallen to about 1-4 ppm resulting in a shut down of the pool for a period of time. Moreover, repeated applications of high levels of certain products, such as chlorine, might prove detrimental to the pool's surfaces and equipment.

Thus, the present invention provides a system for remediating submerged unwanted deposits comprising an inorganic or organic thickening agent and at least one remediation component, the components being blended together to form a homogeneous gel mixture having flow characteristics that will allow the gel to remain in clinging contact with a vertical surface for a sufficient period of time to obtain the intended remediation of the surface with which it is in contact.

In another embodiment of the present invention, the remediation component is incorporated into a film and this permits the film to be deposited on the fouled or contaminated surface for remediation thereof.

Many types of polymeric and nonpolymeric thickening compositions can be used for the purposes of the invention as will be described hereinafter. Similarly, many different types of remediation agents can be utilized for purposes of this invention.

Although the gel and film compositions and products of the present invention contain the two substances mentioned above, they can also contain minor amounts, that is, usually about less than 4% by weight of such material as coloring agents, fragrances, corrosion inhibitors and any other material that has no substantial effect on the performance of the gel or film or the remediation agent.

For example, in the instant invention, one quart of a gel containing 2% (20,000 ppm) sodium hypochlorite could be applied to kill and decolorize about 30 square feet of attached algae without brushing prior to application and with minimal impact on water chemistry. Using the same 10,000 gallon pool, one quart of a gel containing 2% sodium hypochlorite would kill and decolorize algae within about 10-30 minutes but would only add 0.5 ppm of chlorine to the pool. One skilled in the art of water treatment would not reasonably expect that adding only 0.5 ppm of chlorine to the entire body of water would effectively kill algae within minutes, if at all. The instant invention provides rapid results, is less labor intensive and allows the end user to use less of a remediating product than the current treatment paradigm.

A variety of thickening agents is commercially available and can be used in a variety of applications for purposes of the present invention. Many such thickening agents are natural or synthetic polymers which are film formers. Thickeners such as polyacrylamide, polyacrylic acid, guar gum, polyethylene glycol, chitosan, fumed silica, carboxymethlylcellulose, bentonite, polyethers, acacia gum, alginic acid and xanthan gum are well known to those skilled in art of rheology. Mixtures of such materials can also be used. Moreover, a variety of materials are known in the art as materials that can form water soluble films. A partial listing of these would include, polyvinyl alcohol, chitosan, polyoxyethylene, cellulose derivatives such as methyl cellulose, methylhydroxyethyl cellulose, methylhydroxypropyl cellulose, hydroxypropyl cellulose, cellulose, cellulose monoacetate, hydrophobically modified cellulose derivatives, sodium polyacrylate, polylactic acid, lactic acid ethers and esters of polyvinyl alcohol, cellulosics, pullulan, carrageenan, pectin, karaya gum, guar gum, gum tragacanth, sodium alginate, gum arabic, xanthan gum, polyacrylamide, agar, alginate, polyvinyl pyrrolidone and starches. The types of remediating chemistries disclosed herein encompasses the breadth of products used to treat regulated waters such as evaporative cooling towers, industrial process waters, swimming pools, spas, hot tubs, fountains and the like. Since the chemistries of remediation will vary depending on the products, the types of gelling agent, or agents, may vary as well. Without wishing to be bound by scope, remediating products may or may not carry positive or negative charges, may or may not contain halogen or peroxygen oxidizers, metals, or be acidic or alkaline. Therefore, the present invention should not be construed or constrained by the partial list described above. Rather, the invention covers any thickening agent or agents that is or are compatible with the remediating product.

### BRIEF DESCRIPTION OF DRAWINGS

The present invention will be further understood with reference to the accompanying drawings, wherein

FIG. 1 is a photograph showing an algae covered, plaster coupon which has been coated with a gel of the present invention;

FIG. 2 shows that after 20 minutes, the green algae had been decolorized;

FIG. 3 shows a section of a spa, the surfaces of which had become coated with an algae biofilm; and

FIG. 4 shows the results after 20 minutes and indicates areas where a gel had been applied to the vertical surface in the spa and an area with no application of gel.

### DETAILED DESCRIPTION OF THE INVENTION

Regulated bodies of water such as, but not limited to, swimming pools, spas, hot tubs, evaporative cooling towers, pulp and paper process water installations and decorative fountains occasionally require products to treat or prevent any number of undesirable conditions such as, but not limited to, microbial fouling, staining, corrosion or scale deposition. In the case of microbial fouling, organisms such as bacteria, algae or fungi can attach to surfaces and reduce the efficiency of heat exchangers, restrict flow rates or mar the aesthetic quality of water used for recreational purposes. These attached organisms, called biofilms, are covered by an external polysaccharide matrix that also helps protect them from harsh environmental conditions with a concomitant increased resistance to biocides. As a result, biofilms are usually treated by physical disruption via brushing or scrubbing or by using higher levels of biocides. In addition, these same regulated waters are also susceptible to problems such as scale deposition, corrosion, metallic and non-metallic stains.

The current pattern for correcting the foregoing is to treat the entire body of water with an effective amount of sanitizer, biocide, algicide, slimicide, chelating agent, etc. so that the undesirable deposits are killed or removed. In effect, this method of water treatment may use enough of a remediating product to treat tens of thousands of gallons of water even though only a select number of submerged surfaces actually need remediation. Moreover, since the extant paradigm requires treating an entire body of water, more of the remediating product or products are needed and visible results may take days to observe. In summary, methods of the prior art are more expensive, more labor intensive and take longer to work.

For example, according to one embodiment of the present invention gels containing high concentrations (1-2% or 10,000-20,000 ppm) of NaOCl can effectively destroy algal biofilms within minutes. To generate 10,000 ppm chlorine residual in a 10,000 gallon swimming pool it would be necessary for the pool operator to add approximately 1,250 pounds of calcium hypochlorite or 5,000 gallons of 20% sodium hypochlorite. While this level of chlorine would effectively eliminate the algal slime, this scenario would be cost and labor prohibitive. Moreover, this amount of chlorine would also result in potentially irreparable damage to all pool surfaces, and to all of the pool's integral equipment (plumbing, pump, filter, heater, etc.). Clearly, the present invention discloses novel methods and compositions that can achieve the positive results of extreme chemical treatment (biofilm destruction in minutes) while at the same time obviating the negative consequences (prohibitive cost and labor, destruction of pool surfaces and equipment).

For the present invention, a variety of products were thickened into gels or films, which contained at least one of oxidizers, algicides, slimicides, chelating stain removers or other commercially valuable compounds. Additional embodiments of this invention consisted of gels containing disparate components that produce an efficacious treatment when mixed.

According to one embodiment of the invention, a gel containing a thickener such as polyacrylic acid and sodium hypochlorite is applied to a sponge to coat the sponge with a layer of gel of sufficient thickness to be able to be applied to a portion of a wall of a swimming pool below the water level that is coated with algae. The sponge is fastened to a long pole of the type customarily used around pools for maintenance purposes. The gel has a consistency sufficient to cling to the sponge and then the sponge is immersed into the pool and gently pressed against the algae covered wall without dislodging any significant amount of the algae into the surrounding water of the pool. The gel containing the polyacrylic backbone or matrix, sodium hydroxide and bleach takes from about 30 seconds to a few minutes to decolorize the algae. The pH of the gel is typically about 11, although this can vary. The sodium hypochlorite diffuses from the gel to the wall. The cross linked polyacrylic acid is insoluble in water at neutral pH. However, it ionizes to polyacrylate at alkaline pH and slowly returns to the free acid state in the typical pool pH range of 7.2 to 7.8.

Swimming pools that are sanitized with traditional sanitizers such as chlorine or bromine and pools treated with non-traditional or specialty sanitizers such as

poly (iminoimidoimidocarbonyliminiohexamethylene)hydrochloride, also referred to as polyhexamethylene biguanide (PHMB) are susceptible to biofilm formation. However, unlike traditional sanitizers, PHMB is incompatible with the most common and cost effective remedial chemistries. Specifically, chlorine cannot be used to treat biofilms in PHMB pools or spas under the current water treatment paradigm. Chlorine quickly reacts with PHMB causing a loss of the sanitizer and a destruction of water quality.

However, the present invention has the advantage in that it allows for the measured use of chlorine in PHMB and peroxide treated systems without appreciable loss of PHMB, hydrogen peroxide or deterioration of water quality.

To prepare the gel, the ingredients are mixed together, typically using a high speed mixer at room temperature. No pH adjustment is usually required. Some of these gels have thixotropic properties.

Typically not more than 2% bleach is added to the gel to form a stable gel capable of clinging to a sponge or vertical surface.

The following examples serve to illustrate, without limiting, the present invention.

### EXAMPLE 1

A gel containing 3% polyacrylic acid (PAA), 5% sodium hydroxide (NaOH), and 1.87% sodium hypochlorite (NaOCl) and assayed with 0.1 N sodium thiosulfate to verify NaOCl concentration. To prepare 200 ml of said gel, 10 g of NaOH were dissolved in 90 ml of deionized water. Next, 6 g of polyacrylic acid (Carbopol 676) were added to the alkaline solution with vigorous stirring. Finally, 94 ml of NaOCl (4.254%) were added to the mixture with continued stirring. Approximately 2 g of gel were spread across an algae-covered plaster coupon (ca. 1 in.×1 in.). As shown in FIG. 1, the gel coated coupon was then placed into a beaker containing 300 ml of balanced pool water containing 222 ppm calcium hardness, 115 ppm total alkalinity and pH 7.4. Within 20 minutes, the green algae had been decolorized, as shown in FIG. 2.

### EXAMPLE 2

Gel used in Example 1 was tested in an actual spa whose surfaces were covered with a greenish yellow algae biofilm, as shown in FIG. 3. The water chemistry of the spa was as follows: 444 ppm calcium hardness, 65 ppm total alkalinity and pH 7.6. A small amount (ca. 15 ml) of NaOCl-containing gel was applied to a flat brush and applied directly to the attached algae without dislodging any significant amount of the algae into the surrounding pool water. Within twenty minutes the area smeared with the gel was white with little trace of algae. By contrast, when another area was brushed without using gel, little of the algal biofilm was removed. This is shown in FIG. 4. Therefore, the surprisingly fast remediation was due to the chlorine gel and not to a mere physical removal.

### EXAMPLE 3

An 85 gallon tank was filled with pool water containing 8.5 ppm of polyhexamethylene biguanide (PHMB) and 122 ppm of hydrogen peroxide. The water inside the tank was balanced and contained 340 ppm calcium hardness, 97 ppm total alkalinity and a pH of 7.8. The tank was fitted with a skimmer, maindrain, return line, pump, sand filter and flowmeter to model the critical performance characteristics of a swimming pool. The flow rate for the unit was ca. 0.39 gallons per minute and this was equivalent to a turnover rate of 3.6 hours. Approximately 12.7 ml (11.17 g) of a gel containing ca. 1.8% NaOCl were placed onto an algae-covered plaster coupon having the rough dimensions of 5 in.×4.5 in. The amount of NaOCl-containing gel used was equivalent to adding 1.6 quarts of the same gel to a 10,000 gallon pool. Within 30 minutes, the algae on the plaster coupon were significantly decolorized. At the conclusion of the test, a water sample was collected from the area of the Coupon and analyzed to determine if the chlorine treatment adversely affected water balance parameters. Testing revealed that water parameters were largely, and surprisingly, unaffected by the concentrated chlorine treatment. The water in the tank now contained 340 ppm calcium hardness, 105 ppm total alkalinity, pH 7.8, 8.4 ppm PHMB and 120 ppm hydrogen peroxide. These results were unexpected since free chlorine immediately reacts with PHMB to quickly form an aesthetically displeasing conglomeration in water. Moreover, chlorine neutralizes hydrogen peroxide thereby eliminating the system's oxidizer according to the following equations:
NaOCl+H₂O→HOCl+NaOH
2 HOCl+H₂O₂→2 H₂O+O₂+2 Cl⁻

Even though the reactions of available chlorine with PHMB or hydrogen peroxide are diffusion controlled, the present invention allows for the use of concentrated chlorine compositions in combination with PHMB and peroxide treated waters with no negative impact on water chemistry. Since the chlorine is concentrated and sequestered within a thickened matrix applied directly to the site of an unwanted deposit, the chlorine is likely to react with the deposit more readily than with components throughout the bulk water.

### EXAMPLE 4

Citric acid, a tricarboxylic acid, ionizes in aqueous buffered solutions to form citrate ions. By virtue of its negative charges, the citrate ion has the ability to chelate metals such as copper. Unchelated copper will stain submerged surfaces under certain conditions. Therefore a gel was prepared containing 3% high molecular weight chitosan and 10% citric acid. It is now disclosed that this gel, when applied to submerged metal stains, will deliver citric acid/citrate directly to metal stains in order to remove them. It is understood by those skilled in the art that any number of metal chelators could be used in lieu of citric acid to achieve essentially the same or greater effect.

### EXAMPLE 5

Another embodiment of the present invention involves the use of solid films that are impregnated with chemicals that can be applied to submerged surfaces in order to remove, kill, decolorize or generally remediate unwanted deposits. An example of this embodiment was produced by preparing a gel containing approximate amounts of the following: 2.5% polyacrylamide, 5% glycerol with the remainder being largely water. The gels (ca. 35 ml in thickness) were placed into plastic petri dishes (3.5″×3.5″) and placed into a 50° C. oven. Upon drying for 2 weeks, the gels were dry, yet readily pliable. These types of films which have a thickness typically in the range of 10 to 55 mm can offer enhanced convenience in that they can be placed directly onto surfaces to kill, decolorize, oxidize or generally remediate unwanted deposits without having to spread gels onto these surfaces. The thickness of the film is not critical and depends on the selected formulation of the gel and the particular intended use.

### EXAMPLE 6

Another embodiment of the instant invention is the use of gels containing disparate materials that when mixed, produce desirable compounds that can effectively remediate unwanted deposits. A gel containing 3% polyacrylic acid, 5% sodium hydroxide and 20% ammonium sulfate was prepared. This gel could be combined with another gel containing chlorine to produce chloramines in situ to treat submerged surface deposits. It is widely accepted that chloramines are more effective against biofilms than free chlorine. In this embodiment two gels are prepared, each containing a material that will react with the material in the other gel. Therefore, the two gels are separately stored, each in its own package as a two package system. When it is desired to treat the contaminated surface, the two gels are mixed and quickly applied to the surface.

In another embodiment a gel containing sodium chlorite and another gel containing a chlorite-activating compound are combined shortly before application to the surface to be treated, such that the combination of the two gels would produce chlorine dioxide. Suitable chlorite-activating compounds are those compounds that can convert ClO₂⁻ to ClO₂.

Chlorine dioxide forming gels can be placed directly onto surfaces containing organisms or deposits that might be resistant to even high levels of chlorine. Protozoan oocysts such as Cryptosporidium parvum and Giardia lamblia are chlorine resistant and can be present in feces. However, they are much more readily destroyed by chlorine dioxide. After fecal accidents in pools, chlorine dioxide forming gels can be applied directly onto the soil deposits to kill pathogens that are less susceptible to chlorine. In this embodiment, two different gels are used. Each gel contains a compound that will react with the active ingredient in the other gel and, therefore, the gels must be separately packaged in a two package system. Just before application to the contaminated surfaces, the two gels are combined and the mix is applied to the area to be treated.

### EXAMPLE 7

Another embodiment of the present invention is the use of gels containing one or more ingredients to utilize multiple functionalities. An example of this type of gel consisted of 3% polyacrylamide, 3% hydrogen peroxide and 10% poly oxyethylene (dimethylimino) ethylene-(dimethylimino) ethylene dichloride. Poly oxyethylene (dimethyliminio) ethylene-(dimethylimino) ethylene dichloride is a polyquaternary ammonium compound that is an EPA registered algicide. As a pool algicide, it is added to deliver concentrations up to about 8 ppm. Hydrogen peroxide is used as a bleaching or oxidizing agent for various water treatment applications. In pool environments it is most commonly applied at about 30 ppm. The present invention discloses a novel application method by which resistant biofilms could be exposed to 100,000 ppm of poly oxyethylene (dimethylimino) ethylene-(dimethyliminio) ethylene dichloride and 30,000 ppm of hydrogen peroxide.

### EXAMPLE 8

Occasionally, fecal accidents occur in regulated waters such as swimming pools and wading pools. When a solid stool is deposited, pool operators must retrieve it from the bottom of the pool and bring it up to the surface of the water. During the transport of the stool, bacteria and other pathogens in the feces can be released into the bulk water. Therefore, another embodiment of the present invention is a method for controlling the release of pathogenic bacteria, viruses and protozoa from solid fecal material by coating said material with a gel or a combination of gels that contain antimicrobial substances. The gel or gels would provide a physical barrier to slow the release of bacteria, viruses and protozoa. Moreover, the antimicrobial substance or substances contained within the gels would complement the effectiveness of the physical barrier by killing the bacteria, viruses and protozoa as they are released from the stool, Alternatively, films containing antimicrobial substances could be used to achieve essentially the same result as the gel or gels.

Without wishing to be bound by scope, one potential means of applying the gel or plurality of gels, or film or plurality of films, to the submerged fecal material is to use a pole or other suitable device that is able to dispense or apply the Theologically modified antimicrobial solutions directly to the surface of the feces.

### PREFERRED EMBODIMENTS OF THE INVENTION

The present invention provides a simple, convenient and reliable means of applying remediating treatments to surfaces that are below water. Those skilled in the art of treating regulated waters will understand that it is desirable to remove unwanted deposits such as biological growths, contaminations or stains from surfaces below water. Moreover, those skilled in said art will also understand the inconvenience of treating an entire body of water merely to kill or remove surface deposits.

The instant invention discloses compositions and methods for the use of said compositions that comprise solutions and thickeners that alter the rheology (i.e., their ability to flow or be deformed) of said solutions. The thickened solutions are thus rendered capable of adhering to submerged surfaces. Rheologically modified solutions can contain a variety of beneficial water treatment chemicals suitable for eliminating undesirable depots on submerged surfaces. A partial listing of such beneficial chemicals would include compounds of at least one of chlorine, bromine, and iodine, as well as hydrogen peroxide, organic peroxides, sodium chlorite, algicides, quaternary ammonium compounds, stain removing compounds, chemical reactants, chloramines, chloramide or chlorimide-producing compounds, acids and bases.

It is understood that the aforementioned does not constitute an exhaustive list and that the present invention is not limited to this those beneficial compounds contained therein. Additionally, the preferred and most likely embodiments of the present invention would constitute adding rheology modifiers to the solution containing the beneficial water treatment compounds.

Preferred compositions and methods would involve adding appropriate thickening agents to solutions containing beneficial compounds that produce desirable results when added to water or to surfaces submerged in said water. Preferred thickeners can be organic, inorganic, polymeric, oligomeric, trimeric, dimeric or monomeric. Moreover, preferred thickeners may be generally cationic, anionic, amphoteric or nonionic in nature. A partial list of thickeners includes acrylic polymers, cross-linked acrylic polymers, alginates, associative thickeners, carrageenan, tapioca, microcrystalline cellulose, carboxymethylcellulose, hydroethylcellulose, hydroxypropylcellulose, hydroxypropylmethylcellulose, methylcellulose, microcrystalline cellulose, guar and guar gum derivatives, locust bean gum, clays, polyethylene, polyethylene oxide, polyvinyl pyrrolidone, silica gel, xanthan, chitosan, polyacrylamide, polyethylene glycol. Preferred thickeners will be chemically compatible with the remediating agent or agents and will produce the desired degree of rheological modification.

Without wishing to be bound by scope, ranges for remediating chemistries contained within gels or films will usually contain 0.01-80% of said chemistries with the remainder comprising water, additives and the rheology modifiers. More preferably the remediating chemistries contained in gels and films will comprise about 1-40% with the remainder consisting of water, additives and rheology modifiers. Ultimately, the ideal ranges will be determined by the type of thickener used, and by the nature and concentration of the remediating chemistry. Those skilled in the art of rheology modification will understand that all thickeners are not compatible with all remediating chemistries.

Further modifications and variations of the foregoing will be apparent to those skilled n the art and are intended to be encompassed by the claims appended hereto.

I claim:

1. A method for treating a submerged surface to remediate unwanted submerged deposits comprising applying to the submerged unwanted deposit a gel comprising an inorganic or organic thickening agent and at least one remediation component having been blended to form a homogeneous mixture and having flow characteristics that will allow the gel to remain substantially attached to a vertical surface for a sufficient period of time to obtain the intended remediation.

2. The method according to claim 1, wherein the submerged surface is in a regulated water system selected from the group consisting of a swimming pool, wading pool, water park rides and attractions, hot tub, spa, jetted tubs, evaporative cooling tower, pulp and paper processed water, waste water, waste water and fountains.

3. The method according to claim 1, wherein the gel is applied to an applicator and then the applicator having the gel applied thereto, is lowered into the regulated water system, and the applicator then applies the gel to the submerged unwanted deposit.

4. A method according to claim 1, wherein the remediation component is a member selected from the group consisting of a compound capable of releasing chlorine, bromine or iodine, a non halogen oxidizer, a chelating agent, quaternary ammonium compound, a biocidially active metal, a stain or scale remover, alcohol or a water balance detector.

5. A method according to claim 1, wherein the gel is a member selected from the group consisting of polyacrylic acid, carboxymethyl cellulose, carboxyethyl cellulose, gums, chitosan, polyacrylamide, alginic acid and mixtures thereof.

6. A method according to claim 1, wherein the gel additionally contains a coloring agent, fragrance or corrosion inhibitor.

7. A method for treating a submerged surface in a regulated water environment in need of remediation compromising placing a film on the said submerged surface, said film compromising an organic gel and at least one remediation component, wherein the remediation agent is selected from the group consisting of a sanitizer, oxidizer, slimicide, algicide, chelating agent, stain remover, scale remover, alcohol, water balance detector, quaternary ammonium compound and mixtures thereof.

8. A method of treating a submerged surface in a regulated water system in need of remediation compromising applying a film to the said submerged surface, said film consisting essentially of an organic gel and at least one remediation component.

9. A composition for remediating submerged deposits comprising:
an inorganic or organic thickening agent in the form of a gel and at least one remediation component which have been blended together to form a homogenous mixture having flow characteristics that will allow the gel to remain substantially attached to a vertical surface under water for a sufficient period of time to obtain the intended remediation.

10. A composition for remediating submerged deposits of feces or stool comprising:
an inorganic or organic thickening agent in the form of a gel and at least one remediation component which have been blended together to form a homogenous mixture.

11. The gel composition according to claim 9, wherein the remediation component in the first gel is a member selected from the group consisting of a sanitizer, oxidizer, slimicide, algicide, chelating agent, stain remover, scale remover, alcohol, water balance detector, quaternary ammonium compound and mixtures thereof.

12. The gel composition according to claim 9, wherein the gel composition can remain attached to a vertical surface for at least one half hour at 10° C.

13. The gel composition according to claim 9, further containing minor amounts of a member selected from the group consisting of a coloring agent, fragrance, a corrosion inhibitor and mixtures thereof.

14. The gel composition according to claim 9, wherein the organic thickening agent is a member selected from the group consisting of polyacrylic acid, carboxymethyl cellulose, carboxyethyl cellulose, gums, chitosan, polyacrylamide, alginic acid and mixtures thereof.

15. A two package system for remediating submerged deposits comprising:
a first gel composition for remediating submerged deposits comprising an inorganic or organic thickening agent and at least one remediation component which have been blended to form a homogenous mixture having flow characteristics that will allow the gel to remain substantially attached to a vertical surface for a sufficient period of time to obtain the intended remediation and
a second gel composition for remediating submerged deposits comprising an inorganic or organic thickening agent and at least one remediation component which have been blended to form a homogenous mixture having flow characteristics that will allow the gel to remain substantially attached to a vertical surface for a sufficient period of time to obtain the intended remediation,
wherein said first and second gel compositions are different and are maintained separated to prevent unwanted reaction.

16. The gel composition according to claim 14, wherein the remediation component the first gel is a member selected from the group consisting of a sanitizer, oxidizer, slimicide, algicide, chelating agent, stain remover, scale remover, alcohol, water balance detector, quaternary ammonium compound and mixtures thereof.

17. The gel composition according to claim 14, wherein the gel composition resulting from mixing the first and second gels can remain attached to a vertical surface for at least one half hour at 10° C.

18. The gel composition according to claim 14, wherein each gel has a sufficient viscosity to enable the composition to remain submerged for a sufficient period of time to obtain the intended remediation.

19. The two package system according to claim 14 wherein at least one of said first and second gels contains minor amounts of a member selected from the group consisting of a coloring agent, fragrance, a corrosion inhibitor and mixtures thereof.

20. The two package system according to claim 14, wherein the organic thickening agent in each gel is a member selected from the group consisting of polyacrylic acid, carboxymethyl cellulose, carboxyethyl cellulose, gums, chitosan, polyacrylamide, alginic acid and mixtures thereof.

21. A film for remediating submerged unwanted deposits compromising an organic thickening agent and at least one remediation component, said film being capable of existing in a submerged aqueous condition without dissolving for at least one-half hour at 10° C.

22. A film for remediating submerged unwanted deposits of feces or stools compromising an organic thickening agent and at least one remediation component, said film being capable of existing in a submerged aqueous condition without dissolving for at least one-half hour at 10° C.

23. A gel composition in the form of a pliable film for bleaching, removing or inhibiting the deposition of microbial slime, stains or other unwanted deposits compromising an organic thickening agent and at least one component for treating the submerged and unwanted deposit and being of a sufficient viscosity so as to allow the gel composition to remain substantially attached to a vertical surface for a sufficient period of time to obtain the intended remediation.

24. The gel composition in the form of a pliable film according to claim 21, which contains a chlorine, bromine, or iodine releasing compound, nonhalogen oxidizer, chelating agent, quaternary ammonium compound, biocidally active metal, stain or scale remover, alcohol or water balanced detector.

25. The gel composition in the form of a pliable film according to claim 21, wherein the thickener is present in the amount of from 0.2 to about 10 percent by weight.

26. The gel composition in the form of a pliable film according to claim 24, wherein the thickener is present in the amount of 0.5 to about 5 percent.

27. The gel composition in the form of a pliable film according to claim 21, wherein the thickener has an average molecular weight of 50,000 to 125,000 and a viscosity at a two weight percent aqueous solution at 25° C. of 50,000 to 100,000 cps.
